(19) United States
(12) Patent Application Publication
(10) Pub. No.: US 2010/0026925 A1
(43) Pub. Date: Feb. 4, 2010

(54) Dynamic image holder

(76) Inventor: Esther Thompson, Atlanta, GA (US)

Correspondence Address: KING & SPALDING, 1180 PEACHTREE STREET , NE, ATLANTA, GA, 30309-3521, US

(21) Appl. No.: 12/221,377

(22) Filed: Aug. 1, 2008

(51) Int. Cl. G02F 1/1333; G09F 1/06

(52) U.S. Cl. 349/58; 40/124.08

(57) ABSTRACT

A dynamic image holder can have a magnetic back and fold-out portions that allow it to adapt from a flat display state to an extended display states, such as in a standing or hanging position. The portions may also be re-positioned so that a customer can resume using the image holder on a flat surface, such as a metal refrigerator or filing cabinet.

### TECHNICAL FIELD

The present invention relates generally to a system, method, and apparatus for holding pictures or other images. More particularly described, the present invention comprises an image holder that can be dynamically adjusted between one or more configurations.

### BACKGROUND

Conventional image holders (e.g., picture frames) come in a variety of sizes and shapes. Often, however, customers of these apparatuses are restricted by the particular configuration in which the holder is manufactured. For instance, an image holder designed to be attached to a refrigerator by the use of a magnet is not adaptable to be used in other configurations, such as in configurations where the holder is hanging from a hook or standing upright. Accordingly, for these and other reasons, there presently exists a need in the art for an image holder that may be easily adapted by a customer for a variety of uses without the need for additional parts or excessive manipulation.

### SUMMARY

The dynamic image holder described herein may comprise an image displaying medium and holder that can be adapted by a customer to fit his or her preferred use of the apparatus. The dynamic image holder may comprise a relatively thin piece of material with a magnetic sheet affixed to its back section (i.e., a magnetic back). The front section of the holder may comprise a medium sufficient to display or hold a picture or other image. For example, a picture may be positioned on the front surface of the holder against a sticky backing material (e.g., a picture mat) and retained beneath a plastic cover.

The magnetic back can be used to affix the holder to metal objects, such as refrigerators, freezers, tool-cases, lunch-boxes, file cabinets, etc. The magnetic back may cover the entire back surface of the holder, with the exception of finger slots (as described herein). The back may also have one or more portions that bend and extend perpendicular from the magnetic picture frame in order to accommodate dynamic positioning. To accomplish this task, pre-formed slits (i.e., dye-cuts) in the magnetic back may allow portions of the magnetic sheet to bend away from the back section of the dynamic image holder. As such, the holder can be configured in many different configurations to satisfy the customer's use without the need for additional components. For example, one portion of the back may extend out to allow the magnetic image holder to be placed on a horizontal surface. A portion of the back may likewise be configured to allow the holder to hang from a vertical surface. Further, if the customer wishes to return the apparatus to its original, flat configuration, he or she may simply fold the extendable portions of the magnet back into the vacated space the portions originally occupied.

### BRIEF DESCRIPTION OF THE DRAWINGS

FIG. 1 is a back elevation view of a dynamic image holder in its flat display state, according to an exemplary embodiment.

FIG. 2 is a back elevation view of a dynamic image holder in its extended display state, according to an exemplary embodiment.

FIG. 3 is a side elevation view of a dynamic image holder, according to an exemplary embodiment.

FIG. 4 is a perspective view of a dynamic image holder, according to an exemplary embodiment.

FIG. 5 is a side elevation view of a dynamic image holder, according to an exemplary embodiment.

FIG. 6 is a back elevation view of a dynamic image holder in its extended display state, according to an exemplary embodiment.

### DETAILED DESCRIPTION OF THE EXEMPLARY EMBODIMENTS

A dynamic image holder comprises a system and apparatus for dynamically adjusting between several different displaying configurations. The front of the image holder may be adapted to hold or retain a picture or other image. In one embodiment, a clear, plastic cover may be form-fitted across the front of the magnetic picture frame such that a picture or other image can be positioned against a sticky backing material (e.g., a picture mat) and retained underneath the plastic cover. In another embodiment, the front of the picture frame may comprise a fixed image. In yet a further exemplary embodiment, the front section of the picture frame may comprise a Liquid Crystal Display (LCD) or other medium for displaying videos or images.

The back of the magnetic picture frame may comprise a magnetic sheet that preferably covers the entire back surface (i.e., a magnetic back). The magnetic back is used to affix the image holder to metal objects, such as refrigerators, freezers, tool-cases, lunch-boxes, file cabinets, etc. The magnetic sheet can be pre-formed with fold-out portions that extend from their regular positions to accommodate dynamic positioning. In an exemplary embodiment, the back may have one or more portions that bend and extend perpendicular from the back surface (i.e., the dynamic image holder may be placed in an extended display state instead of its flat display state). This allows the device to be configured so that it may be placed on a substantially horizontal surface. In another exemplary embodiment, a portion at the top of the back surface may be bent and extended to allow the image holder to be positioned on a hook or other hanging mechanism. In an exemplary embodiment, the pre-cut fold-out portions may be “flattened” back on the back section of the dynamic image holder, if so desired by a customer, in order to use the device on a flat surface. Further, while the entire portion of the back may be magnetic (i.e., the fold-out portions also comprise magnetic material on their outer surfaces), there may be “finger slots”—pre-formed cut-outs—on the back of the holder so that a customer can easily pull the bendable sections from their initial flat position (i.e., the manufactured position). In this way, the customer may easily adjust the picture to either sit or hang using the bendable options pre-formed in the magnetic sheet. It is noted that the back surface may comprise additional or alternative materials for affixing the image holder in its flat display state, including adhesives and suction cups. Also, while the magnetic back may be adhered to the other components of the dynamic image holder with glue or another adhesive material, it is noted that the portions of the magnetic back that bend or extend from the image holder (i.e., the extendable sections or portions) preferably do not adhesive behind them so that the image holder can be easily adjusted from its flat state to its extended state and vice versa.

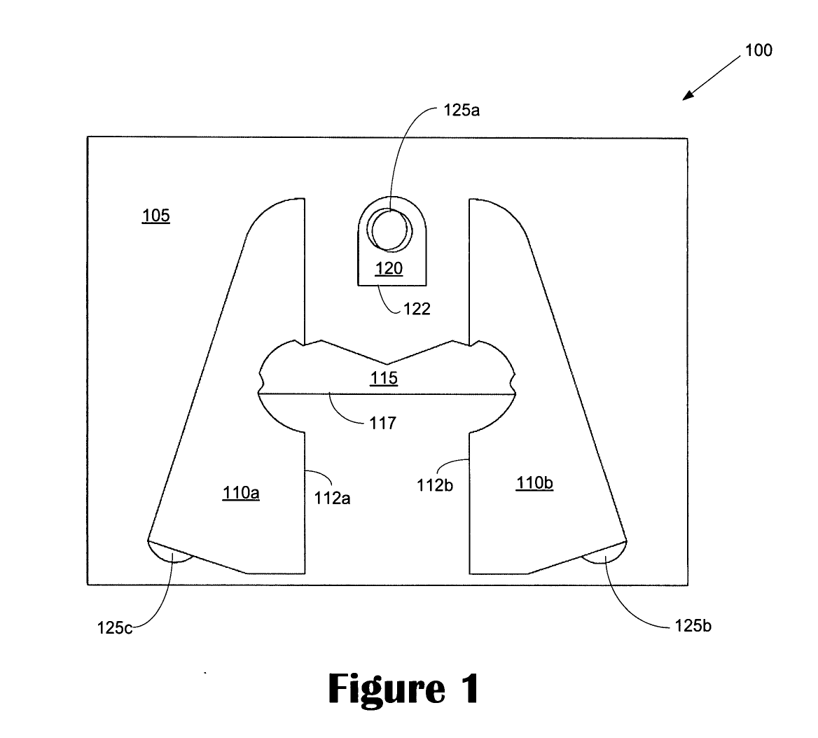

Turning now to the drawings, in which like reference numerals refer to like elements, FIG. 1 illustrates a back surface 105 of a dynamic image holder 100, according to an exemplary embodiment. The dynamic image holder 100 may be of any size, large or small. The back surface 105 preferably comprises a magnetic surface or sheet, but may also comprise any other suitable means (or combination thereof) for attaching the holder to a flat surface, including, but not limited to, adhesives and suction cups. In one exemplary embodiment, substantially the entire back section 105 of the dynamic image holder 100 is covered by a magnetic sheet. Additionally, in one exemplary embodiment, the back section 105 of the dynamic image holder 100 may comprise finger slots 125a, b, and c, whereby a person except for finger slots, as discussed herein). For example, portions of the magnetic sheet on the back section 105 may be removed to form finger slots 125a, b, and c (i.e., the finger slots can be formed from the absence of material on the back section 105).

The back section 105 of the holder 100 may comprise one or more fold-out portions 110a-b, 115, and 120, formed by one or more slits manufactured in the back surface 105, which can bend away from the back 105 of the holder 100 in order to allow the dynamic image holder 100 to stand on a horizontal surface or hang from a wall, according to the particular configuration chosen by the customer. The slits typically are pre-cut on all sides of the fold-out portions 110a-b, 115, and 120, except for an attached side 112a-b, 117, and 122, which remain attached to the back section 105 to provide hinge-like mobility to the fold-out portions 110a-b, 115, 120. Accordingly, the fold-out portions 110a-b, 115, and 120 can bend away from the back section 105 in part because of the pre-formed slits cut around the fold-out portion 110, 115, and 120 and the remaining attached hinge 112a-b, 117, and 122 for the fold-out portion.

In an exemplary embodiment, a user may use the finger slots 125 to access and bend the fold-out portions 110a-b away from the back 105. Further, a stand support 115 may be locked into place against the folded portions 110a-b to allow the holder 100 to be placed on a horizontal surface. The stand support 115 may comprise a horizontal, fold-out portion of the magnetic back 105 located across the middle section of the back of the holder 100. In another exemplary embodiment, a hanging portion 120 of the magnetic back 105 may be folded away from the back 105 to allow the picture frame 100 to be placed on a hook or other hanging mechanism. In either embodiment described above, the fold-out portions 110a-b, 115, and 120 preferably remain connected to the holder 100 through the use of a pre-formed bendable crease in the magnetic back 105 (i.e., a portion of the magnetic sheet may remain intact at the crease where the extendable portion bends away from the remainder of the magnetic back).

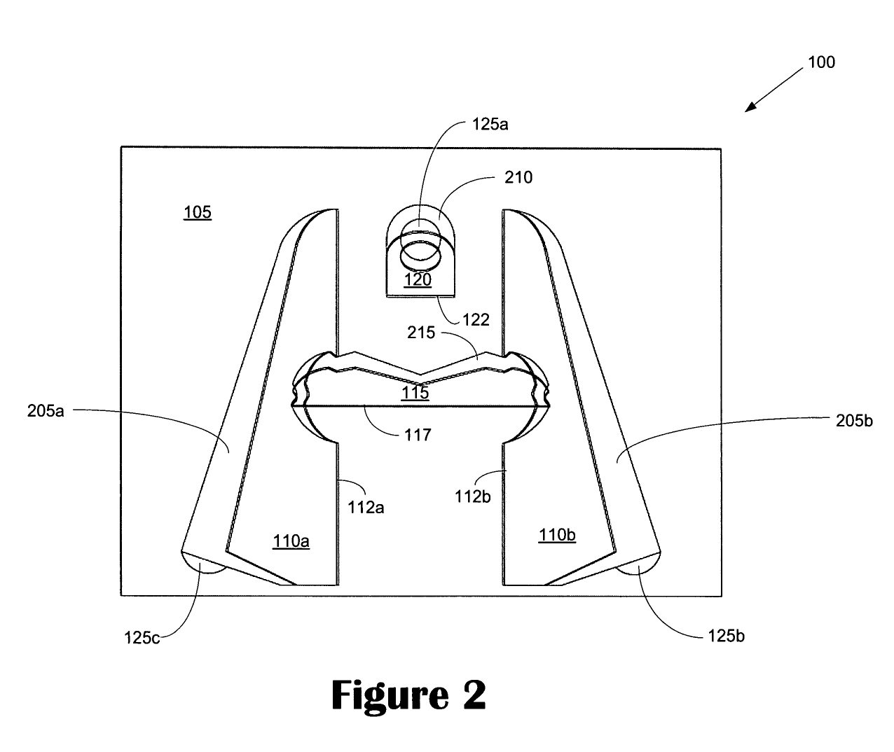

FIG. 2 is a further illustration of a back surface 105 of a dynamic image holder 100, according to an exemplary embodiment of the holder in an extended display state (i.e., a configuration wherein the fold-out portions of the magnetic back are bent away from the back surface). As illustrated, the extendable portions 110a-b, 115, and 120 are folded away from the back 105 in FIG. 2. As such, vacated spaced 205a-b, 210, and 215 are left in the back 105 of the holder where the fold-out portions resided in the flat display state of the dynamic image holder 100. These vacant spaces allow the portions 110a-b, 115, and 120 to fold back into the back 105 if and when a customer chooses to adapt the dynamic image holder 100 to its flat display state again.

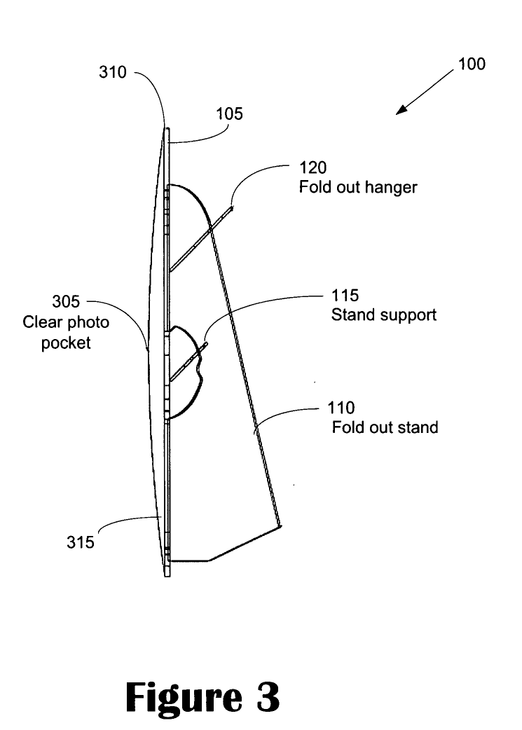

FIG. 3 illustrates a side elevation of a dynamic image holder 100, according to an exemplary embodiment. As illustrated, in an exemplary embodiment the holder 100 may comprise an image display 305 on its front surface 315, such as a clear photo pocket 305. Sticky backing (not illustrated) may be located under photo pocket 305 on the front surface 315 to retain a picture in the image holder 100 in either the flat display state or extended display states. The image holder 100 may also comprise a rigid center section 310. This center section 310 may comprise a piece of cardboard or a piece of aluminum or other metal. The center section 310 may or may not be perforated. In another exemplary embodiment, the dynamic image holder 100 does not comprise a center section 310, but instead comprises only a back surface 105 and front surface 315, wherein the front surface 315 and back surface 105 provide rigidity to the holder 100. It is noted that the front surface 315 may comprise any number of materials, including, but not limited to, cardboard and metal, and, in one exemplary embodiment, may comprise a LCD or other graphical display.

On its back 105, the dynamic image holder 100 may comprise a stand support 115, a fold-out stand 110, and a fold-out hanger 120. The stand support 115 may be used to “lock” the fold out stand 110 into place, so that the dynamic image holder 100 can be placed on a horizontal surface without risk that the fold out stand portion(s) 110 will bend back toward the magnetic back 105. These fold-out portions 110, 115, and 120 may comprise a magnet on their outer surface and, consistent with FIGS. 1 and 2, may be positioned flat against the magnetic back 105 to allow the holder 100 to take on a flat configuration (i.e., flat display state), if so chosen by a customer. Additionally, while the front surface 315 of the dynamic image holder 100 is shown as comprising a photo pocket 305, it is understood that the front surface may comprise any of a number of other image mediums, including an LCD or other digital display capable of showing videos or still images.

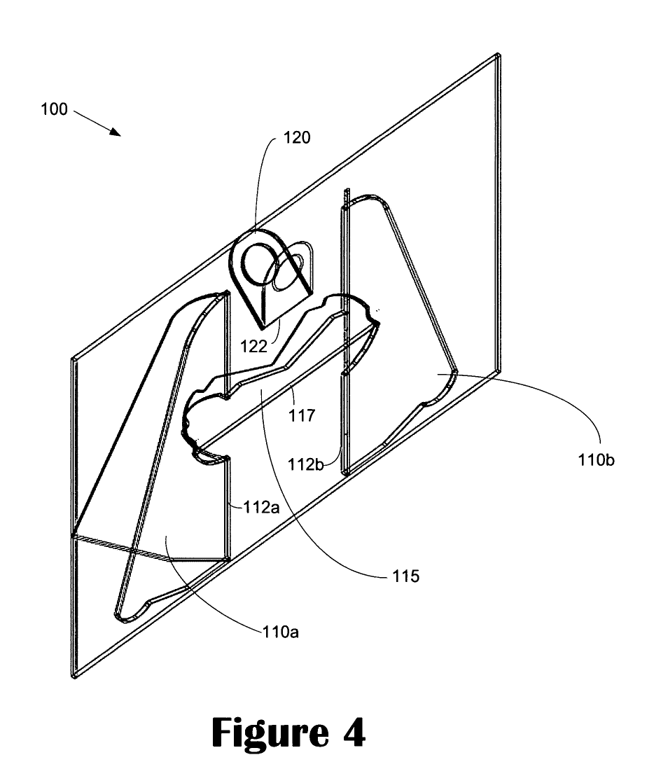

FIG. 4 illustrates a three-dimensional perspective view of an exemplary dynamic image holder 100. As discussed above, the fold-out portions 110a-b and 115 may be use to prop the dynamic image holder 100 on a substantially horizontal surface, such as a nightstand or bed-side table. Additionally, the fold out hanger 120 portion of the dynamic image holder 100 may be used to hang and display images from a hook attached to a vertical surface. Moreover, a user may fold the fold out portions 110, 115, and 120 back into the dynamic image holder 100 to return it to its “flat” display state. In this state, the dynamic image holder 100 may be affixed to a metal surface through the use of a magnetic sheet covering substantially the entire back surface 105 of the holder 100.

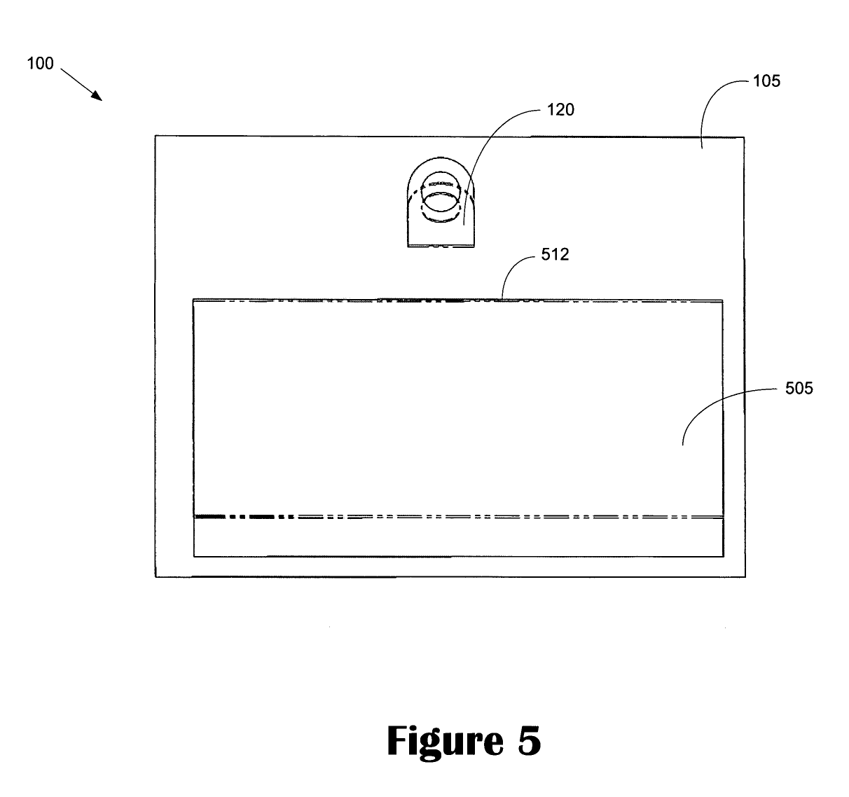

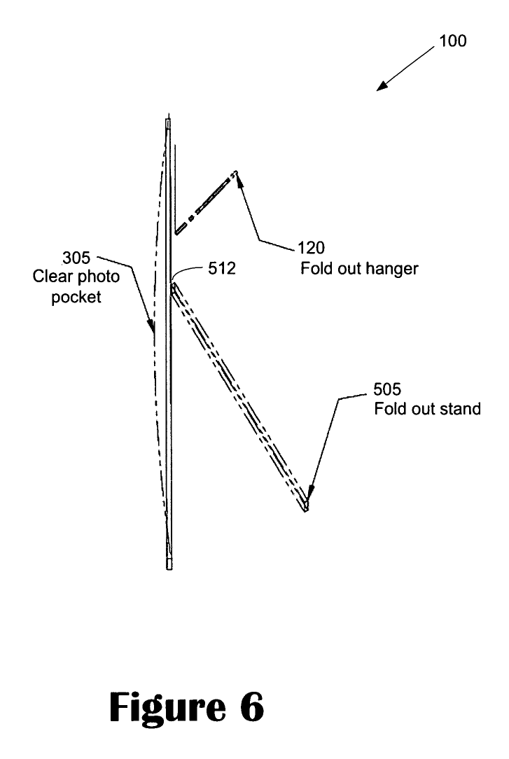

While certain embodiments of the dynamic image holder 100 have been illustrated and described in the attached figures, it is noted that the specific way the fold-out portions of the back 105 bend and manipulate from the dynamic image holder 100 is not intended to restrict the application of the present invention. Instead, it is noted that one of ordinary skill in the art understands that there are other ways to orient and configure the back surface 105 in order to accomplish various other fold-out configurations based on the invention described herein. For example, a different fold-out stand or hanger, such as the fold-out stand 505 illustrated in FIG. 5 and FIG. 6, may be used with the dynamic image holder. In this exemplary embodiment, the fold-out stand 505 comprises a horizontal bendable portion of the back 105 so that the holder 100 can be propped on a substantially horizontal surface to display an image on the front surface of the dynamic image holder 100. As discussed, the fold-out portion, in this case the fold-out stand 505, may comprise one side 512 that always remains attached to the back section 105 of the dynamic image holder 100 to provide a hinge-like mechanism for changing the holder 100 from a flat display state to an extended display state. The front surface of the holder 100 may include, for example, a clear photo pocket 305; a permanent image (which may be printed directly to material, such as cardboard, comprising the front surface 315 of the holder 100; or a digital display or screen, such as an LCD, which can be used to display an image. It is also understood that the image holder 100 may be any size or shape, and can include multiple bendable “stands” or “hangers,” all which are in keeping with the spirit and scope of the present invention.

Accordingly, the foregoing description of the exemplary embodiments of the dynamic image holder has been presented for the purposes of illustration and description only, and is not intended to be exhaustive or the limit the dynamic image holder to the precise embodiments disclosed. Many modifications and variations are possible in light of the above teachings and fall within the spirit and scope of the present invention. The embodiments described herein were chosen in order to explain the principles of the dynamic image holder and their practical application so as to enable others skilled in the art to utilize the dynamic image holder in various embodiments and with various modifications suited to their particular use.

I claim the following:

1. A dynamic image holder, comprising:
a front surface; and
a back surface comprising a magnetic sheet and a fold-out portion for alternating the configuration of the image holder between a flat display state and an extended display state, wherein the fold-out portion comprises a portion of the magnetic sheet.

2. The dynamic image holder of claim 1, further comprising a clear pocket, affixed to the front surface for holding an image for presentation to a viewer.

3. The dynamic image holder of claim 2, wherein the clear photo pocket is configured to retain the image in the flat display state and extended display state.

4. The dynamic image holder of claim 1, wherein the front surface comprises a liquid crystal display (LCD).

5. The dynamic image holder of claim 1, wherein the back surface comprises finger slots for extending the fold-out portion.

6. The dynamic image holder of claim 1, wherein the back surface comprises a suction cup to affix the holder to a surface in the flat display state.

7. The dynamic image holder of claim 1, wherein the fold-out portion comprises a fold-out hanger.

8. The dynamic image holder of claim 1, wherein the fold-out portion comprises a fold-out stand.

9. The dynamic image holder of claim 8, further comprising a stand support for stabilizing the fold-out stand.

10. The dynamic image holder of claim 1, further comprising a center section to provide rigidity to the image holder.

11. An image holder, comprising:
a back surface comprising a magnet extending along substantially the entire portion of the back surface;
a center section comprising a material that provides rigidity to the image holder;
a front surface for presenting an image to a viewer; and
an extendable portion in the back surface for supporting the image holder in a flat display state and an extended display state.

12. The image holder of claim 11, further comprising a clear pocket, affixed to the front surface for holding the image for presentation to the viewer.

13. The image holder of claim 12, wherein the clear pocket is configured to retain photos in the extended display state.

14. The image holder of claim 11, wherein the front surface comprises a liquid crystal display (LCD).

15. The image holder of claim 11, wherein the back surface further comprises a suction cup to affix the image holder to a surface.

16. The image holder of claim 11, wherein the extendable portion comprises a fold-out hanger.

17. The image holder of claim 11, wherein the extendable portion comprises a fold-out stand.

18. The image holder of claim 18, wherein the extendable portion further comprises a stand support for stabilizing the fold-out stand.

19. The dynamic image holder of claim 11, wherein the back section further comprises finger slots for assisting in changing the image holder from a flat display state to an extended display state.

20. A dynamic image holder, comprising:
a back surface comprising a magnetic sheet;
a front surface affixed to the back surface for retaining an image; and
one or more slits surrounding an extendable portion of the back surface such that the extendable portion can extend from the back surface to form an extended support for the dynamic image holder.
